(19) United States
(12) Patent Application Publication
(10) Pub. No.: US 2006/0166818 A1
(43) Pub. Date: Jul. 27, 2006

(54) Resin bonded sorbent

(76) Inventors: Thomas Powers, Mayville, NY (US); Samuel A. Incorvia, North Tonawanda, NY (US)

Correspondence Address: SIMPSON & SIMPSON, PLLC, 5555 MAIN STREET, WILLIAMSVILLE, NY, 14221-5406, US

(21) Appl. No.: 11/040,471

(22) Filed: Jan. 21, 2005

(51) Int. Cl. B01J 20/22

(52) U.S. Cl. 502/401

(57) ABSTRACT

A resin bonded sorbent composition comprising 25-55 wt % sorbent, preferably molecular sieve, and 45-75 wt % resin. A preferred resin is nylon. A preferred amount of molecular sieve is 35-42 wt % and a most preferred amount is 40 wt %. Also included is a refrigeration cycle component made from a composition comprising 25-55 wt % molecular sieve and 45-75 wt % resin. Also included is a method for manufacturing a component for a refrigeration cycle comprising the steps of forming a composition comprising 25-55 wt % molecular sieve and 45-75 wt % resin and then molding a component from the composition.

### BACKGROUND OF INVENTION

Incorporation of sorbents into resin matrices has been revealed in several contexts. Formation of these resins into structural or functional shapes by certain processes has been described for various applications. At the same time it is common for fillers to be added to structural molding resins. Low cost mineral or other fillers have been added to resins of the prior art to extend the resin and reduce costs, while maintaining strength sufficient for the intended use of a molded article made from such a resin. It is also a frequent practice to add reinforcing materials such as glass fibers or beads to resins to enhance mechanical properties. With reinforcing additives, just as with fillers, it has been found that there are ranges within which the desired effects of extending or reinforcing the resin are accomplished while maintaining satisfactory injection molding and mechanical properties.

### SUMMARY OF INVENTION

The present invention includes a resin bonded sorbent composition comprising 25-55 wt % sorbent, preferably molecular sieve, and 45-75 wt % resin. A preferred resin is nylon. A preferred amount of molecular sieve is 35-42 wt % and a most preferred amount is 40 wt %. A preferred molecular sieve is a 4A molecular sieve.

Also included as a part of the present invention is a refrigeration cycle component made from a composition comprising 25-55 wt % molecular sieve and 45-75 wt % resin.

Still another part of the present invention is a method for manufacturing a component for a refrigeration cycle comprising the steps of forming a composition comprising 25-55 wt % sorbent, preferably molecular sieve, and 45-75 wt % resin and then molding a component from said the composition.

### BRIEF DESCRIPTION OF THE FIGURES

The features of the invention believed to be novel and the elements characteristic of the invention are set forth with particularity in the appended claims. The figures are for illustration purposes only and are not necessarily drawn to scale. The invention itself, however, both as to organization and method of operation, may best be understood by reference to the detailed description which follows taken in conjunction with the accompanying drawings in which:

FIG. 1 is an end view of an accumulator in accordance with the present invention;

FIG. 2 is a partial cross sectional side view of an accumulator in accordance with the present invention;

FIG. 3 is an exploded view of a filter/desiccant bag/aluminum fitting component of a refrigeration system in accordance with the prior art;

FIG. 4 is a side view of the component of FIG. 3;

FIG. 5 is a one-piece filter/fitting made in accordance with the composition of the present invention;

FIG. 6 is an illustration of the use of the device shown in FIG. 5 along with a desiccant bag;

FIG. 7 shows a cross sectional view of an embodiment of the part shown in FIG. 5 in use atop a condenser;

FIG. 8 illustrates a mobile refrigeration accumulator baffle portion of a refrigerant vapor/liquid separator such as is used in the receive of an automobile air conditioning system, made in accordance with the present invention; and

FIG. 9 illustrates a cap portion for the separator of FIG. 8.

### DETAILED DESCRIPTION OF THE INVENTION

It would be desirable for reasons of cost and productivity to incorporate a sorbent into a resin, and in particular one suitable for injection molding, in such a way that its adsorptive function was preserved and the molding properties of the resin were maintained while mechanical properties were not degraded.

It has been found, as a part of the present invention, that certain sorbents in certain resins have the beneficial effect of reinforcing the resin while retaining the adsorptive capacity. It has also been found as a part of the present invention that, within limits, these resins can be processed and formed by several techniques, including modem high-speed injection molding processes into fully functional component parts, including parts for various sealed systems and assemblies. In these later applications, the structural and functional purposes are served while ambient and ingressed moisture is adsorbed to protect sensitive materials or components of systems or assemblies from degradation by moisture; e.g. hydrolysis or corrosion.

In accordance with the above, the present invention includes a reinforced structural resin composition suitable for injection molding with improved mechanical properties, satisfactory melt handling properties, and beneficial and substantial moisture adsorption properties. A composition in accordance with the present invention comprises 25-55 wt % sorbent and balance resin, and preferably 25-45 wt % sorbent with balance resin. A more preferred composition comprises 35-42 wt % molecular sieve and balance resin. A most preferred resin composition is 60% nylon molding resin such as Zytel 101, compounded with 40% molecular sieve such as W. R. Grace 4A molecular sieve powder. This molecular sieve has a nominal pore size of 4 and has a particle size range of 0.4 to 32μ. It is noted, however, that other sized molecular sieves could be used, such as 3A, 5A, or 10A, for example. Furthermore, the invention includes other sorbents, such as silica gel, activated carbon, activated alumina, clay, other natural zeolites, and combinations thereof. Still further, it is noted that, depending on the particular application, other additives could be used to aide in manufacture and/or performance. Such additives include surfactants, coupling agents, or compatibilizing agents, as well as processing aids and the like.

In the case of most mobile refrigeration systems, however, due to performance issues, there are preferably no other materials mixed with the resin/sorbent combination as defined above.

For comparison, a commonly used reinforcing glass bead was compounded at about the same loading. The resin chosen was one known to be compatible with refrigerants used in modern air conditioning systems, specifically R-134a and R-152a. The resin is also compatible with compressor lubricants entrained in the refrigerant stream. The desiccant is the same as that most commonly used in conventional systems, namely a 3A or 4A molecular sieve.

The compounded resin mechanical properties are compared with the pure polymer and with glass reinforced polymer in Table I.

TABLE I
Properties of Reinforced Nylon

| | Material: | | |
|---|---|---|---|
| | | Molecular | |
| | | Sieve | Glass Bead |
| | | Reinforced | Reinforced |
| Property: | Nylon Neat | Nylon | Nylon |
| Loading (%) | 0 | 36.6 | 38.2 |
| Hardness - Shore D | 81.4 | 93 | 86.6 |
| Tensile Modulus (psi) | 203779 | 307252 | 361470 |
| Tensile Displacement @ | 0.62 | 0.144 | 0.132 |
| Max Load (in.) | | | |
| Tensile Stress @ Max. | 10907 | 10519 | 10412 |
| Load (psi) | | | |
| Flex Modulus (psi) | 336577 | 439087 | 506988 |
| Flex Displacement @ | 0.531 | 0.142 | 0.156 |
| Yield (in.) | | | |
| Flex Stress @ Yield (psi) | 17114 | 16662 | 15132 |
| Heat Deflection Temp. (° F.) | 111.7 | 144.5 | 131.8 |

As is expected when a resin is reinforced, the hardness is increased and with it the tensile displacement and flex displacement decreases dramatically as the material becomes more metal-like. Accordingly, the tensile and flex modulus increase significantly. With both glass and sorbent reinforced nylon, the tensile and flex stress is substantially maintained. The important feature and the significance of this finding is that the properties of the sorbent reinforced nylon vary from pure nylon in the same way as does glass reinforced nylon, both in direction and magnitude. In addition, the heat deflection temperature is increased. Heat deflection temperature is a measure of heat resistance and is a term known to those skilled in the art. It is an indicator of the ability of the material to withstand deformation from heat over time.

Another preferred resin composition that may be similarly reinforced is a molding resin such as Huntsman PP 6106. This resin is also compatible with today's and tomorrow's refrigerants, as well as with compressor lubricant. It has been compounded in a similar fashion as the nylon example disclosed above, namely: 60% polypropylene resin, and 40% molecular sieve Type 4A. The compounded resin has similar advantageous mechanical properties compared to the pure resin, and performs, structurally, close to that of a glass reinforced resin. Its properties are summarized in Table II.

TABLE II
Properties of Reinforced Polypropylene

| | Material: | | | |
|---|---|---|---|---|
| | | Molecular Sieve | Glass Bead | Glass Fiber |
| | | Reinforced | Reinforced | Reinforced |
| Property: | PP Neat | Polypropylene | Polypropylene | Polypropylene |
| Loading (%) | 0 | 37.5 | 41.9 | 39.4 |
| Hardness - Shore D | 66.8 | 74.6 | 65.6 | 75.4 |
| Tensile Modulus (psi) | 131242 | 228023 | 159321 | 342977 |
| Tensile Displacement | 0.330 | 0.137 | 0.274 | 0.222 |
| @ Max Load (in.) | | | | |
| Tensile Stress @ | 3583 | 3169 | 2188 | 15996 |
| Max. Load (psi) | | | | |
| Flex Modulus (psi) | 113251 | 219377 | 158136 | 737113 |
| Flex Displacement @ | 0.597 | 0.356 | 0.468 | 0.176 |
| Yield (in.) | | | | |
| Flex Stress @ Yield | 14.368 | 14.298 | 9.781 | 60.7 |
| (psi) | | | | |
| Heat Deflection | 121.3 | 145.1 | 128.8 | n/a |
| Temp. (° F.) | | | | |

As expected, reinforcement of polypropylene results in increased hardness and increases in tensile and flex modulus. For each of these properties the sorbent has an even greater effect than glass bead reinforcement. Accordingly, tensile displacement and flex displacement are reduced as the material becomes more stiff. Again, the effect of the sorbent is directionally the same as, but greater than, glass bead reinforcement. Tensile and flex stress is reduced only slightly with sorbent reinforcement. The reduction is greater with glass reinforcement. With this material, the reinforcement with sorbent is generally more effective than with glass bead reinforcement, and the heat deflection temperature is increased.

As may be seen in Table III, melt flow is reduced with sorbent reinforced nylon compared with nylon neat or glass bead reinforced nylon. Nevertheless it is in a workable range and is higher than polypropylene. Melt flow of sorbent reinforced polypropylene is improved relative to polypropylene neat or glass reinforced polypropylene.

TABLE III
Melt Flow Properties of Sorbent Reinforced Polymers

| Melt Flow Index | | Molecular Sieve | Glass Bead |
|---|---|---|---|
| (g/10 min) | Neat | Reinforced | Reinforced |
| Nylon | 56.3 | 14.7 | 55.5 |
| Polypropylene | 5.3 | 7.3 | 2.1 |

Moisture adsorption as a percentage of part weight is significant. This may be seen in Table IV. In practice, molecular sieve will adsorb about 25% of its own weight. It is reasonable then to expect a 40% loaded polymer to adsorb 10% of its own weight. In the case of nylon, however, adsorption reaches 13%. This is presumably the result of action of the sorbent coupled with adsorption of some water by the nylon itself. The fact that the body as a whole adsorbs in excess of 10% indicates that the sorbent in addition to reinforcing the nylon is fully functional as a sorbent even though dispersed in the polymer. There is, in effect, a synergistic effect, or, a double duty by the sorbent. Table IV shows results of adsorption at 36-38% molecular sieve loading.

TABLE IV
Adsorption Properties of Sorbent Reinforced Polymers

Moisture Adsorption @
29° C., 90% r.h.

| | 2 Days | 10 days | 23 days | 38 Days |
|---|---|---|---|---|
| Molecular Sieve | 5.4% | 12.4% | 13% | 13% |
| Reinforced Nylon | | | | |
| Molecular Sieve | 1.1% | 2.8% | 4.4% | 5.7% |
| Reinforced | | | | |
| Polypropylene | | | | |

Polypropylene is hydrophobic and is thus much slower to adsorb moisture. But it is fully functional as a sorbent while being fully functional as a molding resin.

Resin compositions in accordance with the present invention may be prepared using conventional plastics compounding techniques. A preferred sorbent is molecular sieve which can be incorporated into polyamide and polyolefin resins by feeding the sorbent in powder form along with beads of the chosen resin to a plastics extruder with good mixing characteristics. A twin-screw extruder is typically used. Here the resin is melted and the sorbent is mixed throughout. The extruded resin is cooled and then cut or crushed into pellets or granules. Because the compounding is accomplished at high temperatures, the sorbent tends not to adsorb moisture and thus retains its capacity for adsorption.

One advantage realized by the resin/sorbent system of the present invention is that gram for gram, it is more effective than the systems of the prior art. Specifically, the prior art bags of sorbent needed to have beaded molecular sieve wherein the molecular sieve was bound within a binder resin (typically 15 wt % binder) in order for the sorbent to be prevented from entering the stream, such as in the form of a powder. Thus, when one placed 40 grams of a commercially prepared sorbent into a bag, one was placing, in reality, only 34 grams of sorbent into the system (with 6 grams of resin). The present invention, however, requires no additional resin in the sorbent system because the sorbent is being placed directly into the molding resin from which the components are to be made. No intermediary resin binder is therefore required.

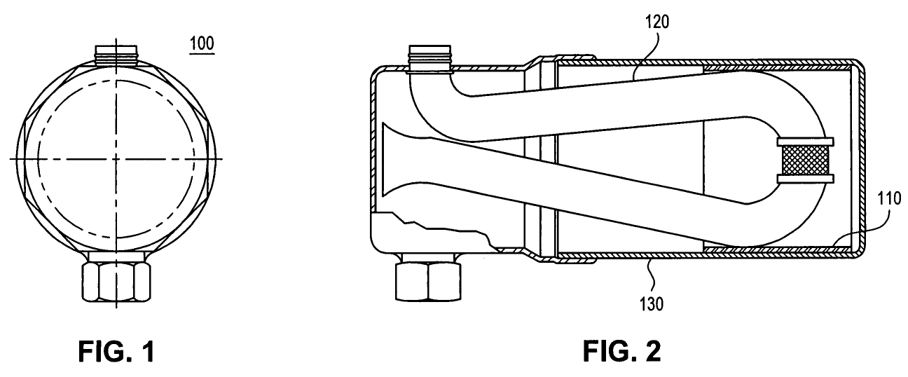

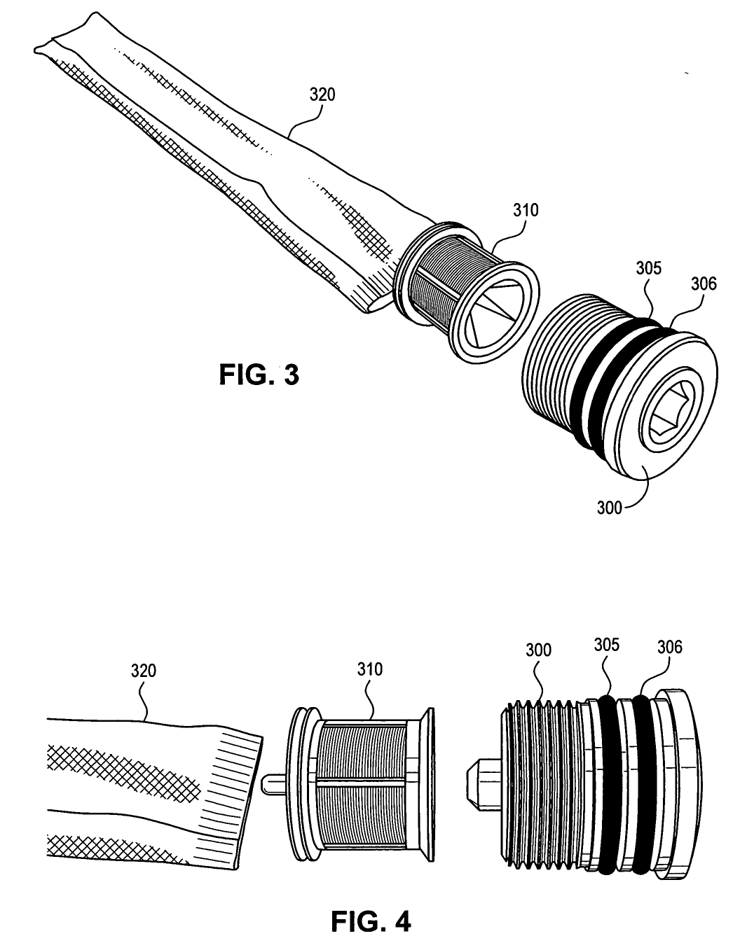

The compounded resin blend defined above can then be injection molded in the form of a part. An exemplary such part is a refrigerant vapor liquid separator such as is used in the receiver of an automotive air conditioning system. The strength of the silicate-reinforced resin results in a structurally sound molded part. As such it is self-supporting and suitable for mounting in the same ways that metal or plastic refrigeration components are presently mounted. See, for example, FIGS. 1 and 2, which show an end and partial cross sectional side view, respectively, of a U-Tube assembly 100. This embodiment; which uses the composition of the present invention to form a liner or sleeve 110 out of the resin bonded sorbent, contains a U-tube 120 within accumulator canister 130. This design provides a means of drying against an exposed inner surface of liner 110. This embodiment is an alternative to a “baffle” type accumulator of the prior art (not shown).

Alternatively, it may be that the resin formed in accordance with the present invention, instead of being melted and injection molded into a functional sorbent part, could be milled or otherwise formed or pelletized into pieces which are then sintered into parts, such as a flow-through monolith structure, such as for a flow-through dryer component. In this case, the part is not injection molded, but is molded from the compounded sorbent-loaded resin into a functional part having sufficient porosity for its intended application, such as for use in a receiver dryer assembly. Parts made from the present invention are particularly well suited to replace multiple-component parts of the prior art. For example, in the past many specialized structures have been developed to fit and secure a desiccant material (which was loose) in various parts of a refrigeration system. Welded or sewn bags containing beaded or granular molecular sieve or aluminum oxide would be disposed within a flow path. Additionally, and specifically with respect to stationary refrigeration applications, beads or granules of desiccant were bonded together in a heated mold with a suitable heat-cured resin or ceramic binder to produce a rigid shape which would serve as a drying block or partial filter. Such a structure would be built into a housing. These solutions, however, involved complicated, multiple part, pieces. The present invention, however, joins the performance of the desiccant with the structural purpose of a part such that a one-piece device serves both functions simultaneously.

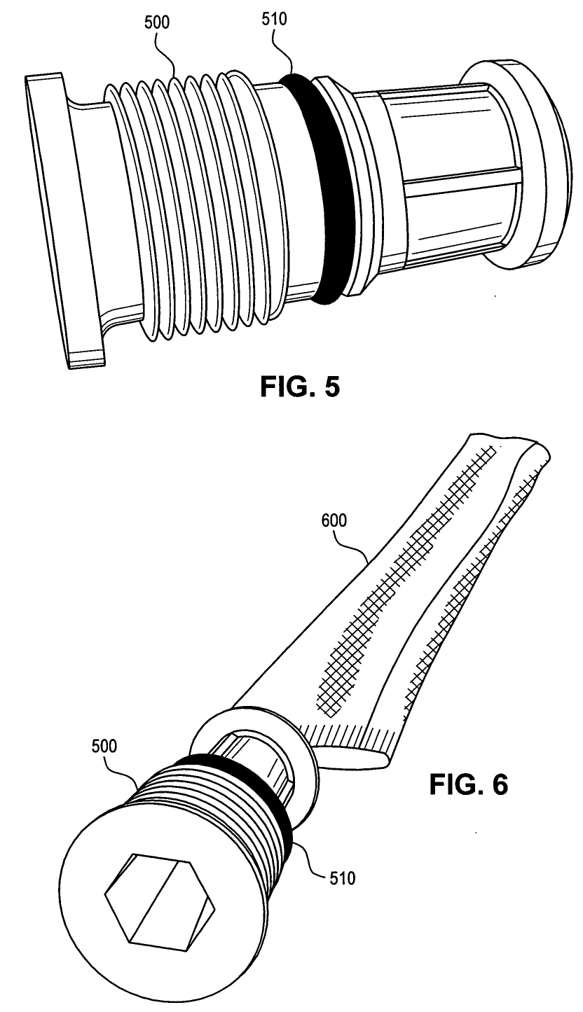

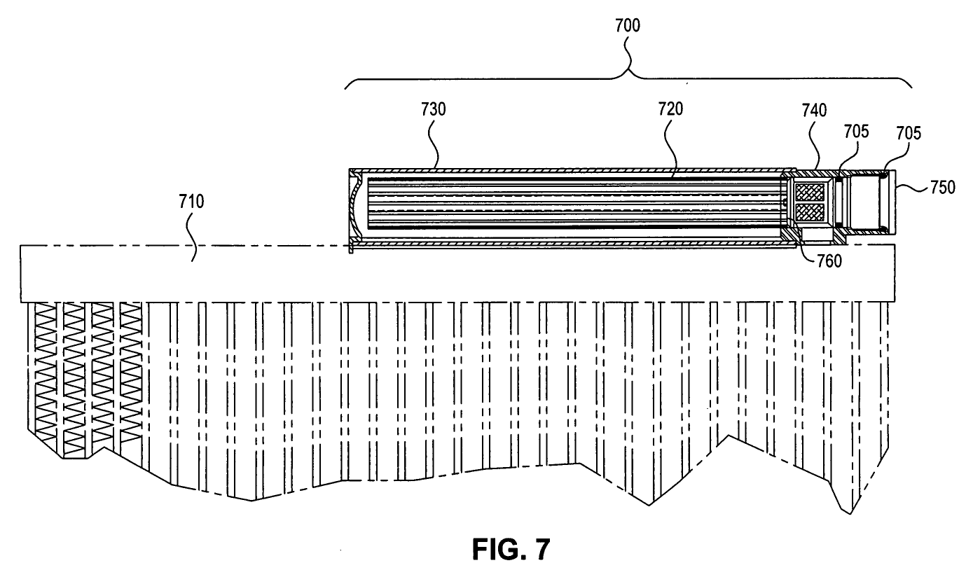

For example, the present invention is contemplated for use with an Integrated Receiver Dehydrator Condenser, such as those which are starting to find their way into a growing number of vehicles. Such mobile refrigeration cycle components basically combine the drying function with the condenser for a number of reasons. It reduces the amount of system components therefore making better use of under-hood space, and concomitantly reduces the number of fittings and connections minimizing the potential for system leaks. It also has some performance gains relative to cooling efficiencies. The current technology is illustrated in FIGS. 3 and 4 which show aluminum threaded plug 300 with O-rings 305 and 306, an injection molded filter 310, and desiccant bag 320. By converting this system to a one-piece injection molded plug/filter assembly, such as that shown in FIG. 5, a one piece plug 500 with O-ring 510 can be utilized. In such a case, plug 500 would be assembled with desiccant bag 600 as shown in FIG. 6. FIG. 7 illustrates a partial cross section of the device assembled.

More specifically, FIG. 7 shows the device 700 disposed adjacent condenser 710. Device 700 is comprised of desiccant bag 720 disposed within receiver dryer tube 730. On the end of device 700 is filter tube 740 housing integral threaded plug and filter 750. O-rings 705 are also shown. Desiccant bag 720 is connected to integral threaded plug and filter 750 at interface 760. This design would eliminate all the separate assembly steps and create a part with fewer separate pieces, as compared to the aluminum threaded plug described above.

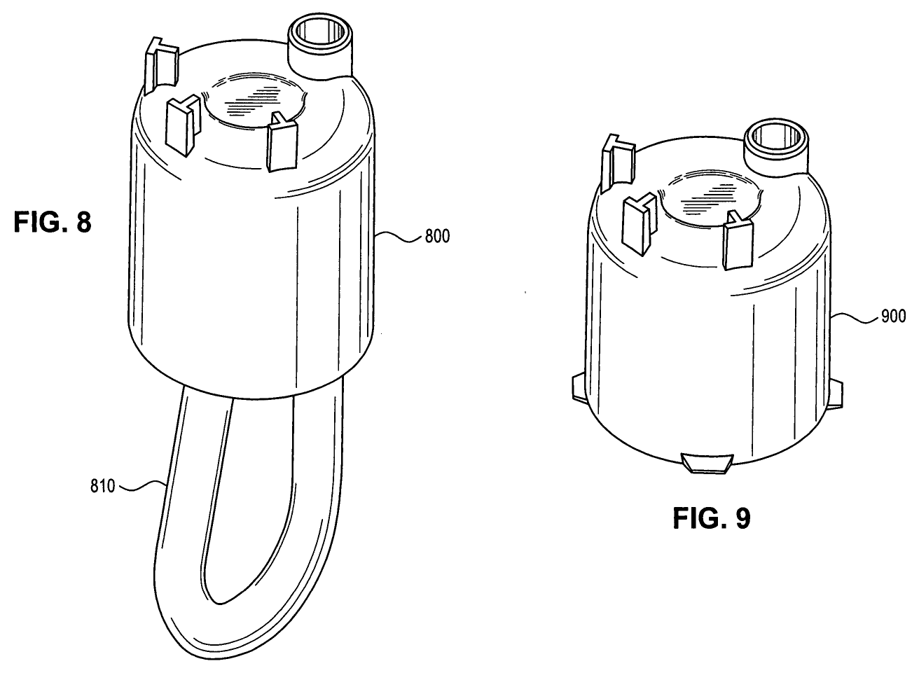

Still another embodiment incorporating the present invention is shown in FIG. 8, which illustrates a mobile refrigeration accumulator upper portion 800 of a refrigerant vapor/liquid separator such as is used in the receiver of an automobile air conditioning system. As can be seen in FIG. 8, accumulator upper portion 800 contains J-Tube 810 which is mounted within it. In this case, one or both of these pieces is molded from the composition of the present invention. FIG. 9 illustrates cap 900 which would be placed over top accumulator upper portion 800. In a preferred embodiment of such an accumulator apparatus, both upper portion 800 and cap 900 would be injection molded and then welded, or possibly injection blow-molded in halves. Completing the device would be a lower portion (not shown) which could also be molded from the composition of the present invention.

Additional applications of this invention are numerous. Such applications would include any resin bonded component or structure used in an air conditioning or refrigeration system. As discussed above, examples include J-tubes that are injection molded in halves and welded or possibly injection blow-molded, sleeve liners, coatings for an interior part or shell, co-injection molded composite structures, and insert molded filter-dryer assemblies. Diagnostic applications would include test strip substrates, case or supports for E-trans cases, containers or components of containers for diagnostic products. Pharmaceutical applications would include parts of a tablet container such as a base, or closure, or the body of the container itself, an insert into a tablet container such as a bottom support or a neck insert to aid in dispensing, a thermoformed sheet or as a layer of a multilayer thermoformable sheet suitable for one-at-a-time or two-at-a-time dose dispensing from a blister or other compartmented package. Electronics and electro-optical device applications would include complete breather filter bodies, inserts for night vision sensor units, or inserts for rear view camera bodies.

It will be appreciated that there are many other potential applications for a desiccant loaded injection moldable resin in closed system and sealed packaging applications. It must also be appreciated that a desiccant loaded injection molding resin can also be extruded into a rod or channel or any other shape with a uniform cross-section because extrusion is a less demanding process than injection molding.

Although the present invention has been particularly described in conjunction with specific preferred embodiments, it is evident that many alternatives, modifications, and variations will be apparent to those skilled in the art. It is therefore contemplated that the appended claims will embrace any such alternatives, modifications, and variations as falling within the true scope and spirit of the present invention.

What is claimed:

1. A resin bonded sorbent composition comprising:
25-55 wt % sorbent; and
45-75 wt % resin.

2. The composition of claim 1 wherein said sorbent is molecular sieve.

3. The composition of claim 1 wherein said resin is polyamide.

4. The composition of claim 1 wherein said resin is polypropylene.

5. The composition of claim 2 wherein said molecular sieve is present at 35-42 wt %.

6. The composition of claim 2 wherein said molecular sieve is present at about 40 wt %.

7. The composition of claim 2 wherein said molecular sieve is a 4A molecular sieve.

8. A refrigeration or air conditioning cycle component made from a composition comprising:
25-55 wt % sorbent; and
45-75 wt % resin.

9. The component of claim 8 wherein said sorbent is molecular sieve.

10. The component of claim 8 wherein said resin is polyamide.

11. The component of claim 8 wherein said resin is polypropylene.

12. The component of claim 9 wherein said molecular sieve is present at 35-42 wt %.

13. The component of claim 9 wherein said molecular sieve is present at about 40 wt %.

14. The component of claim 9 wherein said molecular sieve is a 4A molecular sieve.

15. The component of claim 8 wherein said component is disposed in an accumulator.

16. A method for manufacturing a component for a refrigeration cycle comprising:
forming a composition comprising 25-55 wt % sorbent and 45-75 wt % resin, and
molding said component from said composition.

17. The method of claim 16 wherein said sorbent is molecular sieve.

18. The method of claim 16 wherein said resin is polyamide.

19. The method of claim 16 wherein said resin is polypropylene.

20. The method of claim 17 wherein said molecular sieve is present at 35-42 wt %.

21. The method of claim 17 wherein said molecular sieve is present at about 40 wt %.

22. The method of claim 17 wherein said molecular sieve is a 4A molecular sieve.
